(19) United States
(12) Patent Application Publication
(10) Pub. No.: US 2010/0070431 A1
(43) Pub. Date: Mar. 18, 2010

(54) SYSTEM AND METHOD FOR EVALUATING SECURITIES TRANSACTIONS

(76) Inventor: SCOTT KAYLIE, Lawrenceville, NJ (US)

Correspondence Address: Scott Kaylie, 62 Fountayne Lane, Lawrenceville, NJ, 08648, US

(21) Appl. No.: 12/562,120

(22) Filed: Sep. 17, 2009

Related U.S. Application Data
(60) Provisional application No. 61/192,308, filed on Sep. 17, 2008.

(51) Int. Cl. G06Q 40/00

(52) U.S. Cl. 705/36 R

(57) ABSTRACT

A processor based server for evaluating performance of financial transactions comprises a database containing historical financial data of a plurality of financial assets, a user interface, a controller, a filter and a processor based analytical tool. The user interface communicates with a plurality of client devices over a communications network and receives input from a client device associated with a user. The input comprises information relating to at least two asset-date pairs and a statistic for measuring the performance of the two asset-date pairs. The information on each asset-date pair comprises identifying information of a financial asset and a time period selected by the user for analysis. The processor based analytical tool receives the statistic and the requested historical financial data of the selected financial asset from the database through the controller. The filter divides the requested historical financial data into groups based on association to each asset-date pair such that a first data group comprises a first historical financial data of a first asset-date pair and a second data group comprises a second historical financial data of a second asset-date pair. The analytical tool evaluates the statistic on the first and second data groups to provide first and second resulting values to the controller. The controller converts the first and second resulting values from the analytical tool to first and second graphical values, respectively. The user interface renders graph series for each data group using different type of lines or color on the client device associated with the user based on the first and second graphical values over the communications network.

### RELATED APPLICATION

This application claims the benefit of U.S. Provisional Application No. 61/192,308 filed on Sep. 17, 2008, which is incorporated herein by reference in its entirety.

### FIELD OF THE INVENTION

The claimed invention relates to analytical tools for improving the profitability of investing and trading strategies. More particularly, the claimed invention enables a user to quickly and visually assess the performance of certain statistics (e.g. technical indicators, fundamental ratios) relating to financial assets before and/or after real or hypothetical trade dates, and how that performance differed for different groups of transactions (such as profitable vs. unprofitable trades) of those assets.

### BACKGROUND

Determining which data, technical indicators and fundamental measures contain useful information for creating profitable trading strategies has been an analytical problem for traders and investors ever since stock data has been available. There are literally trillions of combinations of criteria for any trading strategy—hundreds of technical indicators, each of which may require multiple inputs that could be any number, as well as hundreds of financial ratios and other measures that could be trended over time. The invention offers a trader or investor the ability to assess the relative merits of any of these statistics in a very efficient and intuitive manner relative to existing tools, such as backtesting. “Backtesting” is a process whereby a trader or investor describes their strategy to a computer and the computer evaluates that strategy across historical data to determine hypothetical performance (i.e. what assets (e.g. stocks, commodities, currencies, etc.) would have been purchased at what price on what dates and sold at what date for what price). Currently, one popular but inefficient method to determine whether adding a “New Criterion” to a strategy would improve historical profitability, a user could run a backtest on the strategy with and without the New Criterion and compare the results. This is a very inefficient process due to the editing of the computer script describing the strategy and the re-processing of the backtest. In order to check the effectiveness of a different statistic, yet another script needs to be written and run. The claimed invention, however, allows the user to simply click on the Statistic used by the New Criterion and visually see whether the values of that Statistic differ for profitable and unprofitable transactions prior to the date the transactions were executed. If the Statistic's value for each profitable transaction was greater than $35 on the date each such transaction was executed and the value for each unprofitable transaction was less than $35 on the date each such transaction was executed, then a trader might infer that adding a criterion where the Statistic must be above $35 would help them avoid unprofitable transactions in the future, as it would have avoided all prior unprofitable transactions.

A second problem faced by traders and investors that is addressed by the invention is the optimization of unwinding a transaction (i.e. selling an owned asset or purchasing a shorted asset). Many traders and investors impart that they tend to be more comfortable with their decision to buy an asset than they are with their decision to sell it. Given that many investors and traders track their performance on accounting or brokerage systems (which typically show the values of open positions, not the values of closed positions) it is difficult to determine what happened to the value of financial assets after the position was closed. By using the claimed invention which evaluates/analyzes the performance of the assets after the positions were closed, a trader can readily and visually observe whether they have been closing their unprofitable positions too early. The claimed invention provides the traders with the analytical tools and valuable information in modifying their strategy to close losing transactions at later date that historically would have proven more profitable, and potentially increase their profitability.

### SUMMARY AND OBJECT OF THE PRESENT INVENTION

Therefore, it is an object of the claimed invention to provide a system and method that solves the aforesaid problems.

In accordance with an exemplary embodiment of the claimed invention, the inventive system and method calculates and graphically displays how the statistic or statistics underlying the New Criterion for each asset before the trade dates of the assets in the results of the original backtest or the trader's actual trading history. The inventive system and method illustrates the graphical series of these statistics in one color for profitable trades and another color for unprofitable trades and aligns all of the series at each transaction's execution date, thereby enabling the user or trader to determine if there is any useful or significant statistical parameters (i.e., useful/significant statistics) in her trading history for avoiding unprofitable trades to improve profitability. For example, if there are groupings of lines representing the statistic for profitable trades that are distinctly separate from groupings of lines representing the statistic for unprofitable trades in the graph, then the inventive system has identified at least one statistically useful/significant parameter in her trading history based on the New Criterion that can be potentially used to improve her trading profitability. However, if the lines representing the profitable and unprofitable trades are intermingled in the graph, then the inventive system has not identified any statistically useful/significant parameter in her trading history based on the New Criterion.

In accordance with an exemplary embodiment of the claimed invention, the inventive system and method aligns the graphical series based on a predetermined or user selected date, such as the date the positions were closed (e.g. the date an owned stock was sold). By reviewing the series on both sides of the aligned date, the inventive system can graphically present any common trend in any statistic for the unprofitable trades to the trader, which could have prompted the trader to sell the stock sooner or later.

The claimed invention is particularly effective in addressing the aforementioned problems as a result of the ease with which any statistic can be evaluated. To select a statistic to evaluate, the user simply clicks on its representation next to the graph, fills in any required inputs, and the inventive system updates the graph. To evaluate a range of inputs for a given statistic, the claimed invention has a “filmstrip” feature whereby the inventive system determines graphs for each set of inputs and then simultaneously displays the determined graphs. The claimed invention advantageously allows the user/trader to evaluate many statistics visually and almost instantly, rather than editing scripts and re-testing.

In accordance with an exemplary embodiment of the claimed invention, a processor based server for evaluating performance of financial transactions comprises a database containing historical financial data of a plurality of financial assets, a user interface, a controller, a filter and a processor based analytical tool. The user interface communicates with a plurality of client devices over a communications network and receives input from a client device associated with a user over the communications network. The input comprises information relating to at least two asset-date pairs and a statistic for measuring the performance of the two asset-date pairs. The information on each asset-date pair comprises identifying information of a financial asset and a time period selected by the user for analysis. The controller receives the input from the user interface, stores the input in a storage device, requests the historical financial data on the two asset-date pairs from the database, and receives the requested historical data from the database. The processor based analytical tool receives the statistic and the requested historical financial data of the selected financial asset from the controller. The filter divides the requested historical financial data into groups based on association to each asset-date pair such that a first data group comprises a first historical financial data of a first asset-date pair and a second data group comprises a second historical financial data of a second asset-date pair. The analytical tool evaluates the statistic on the first and second data groups to provide first and second resulting values to the controller. The controller converts the first and second resulting values from the analytical tool to first and second graphical values, respectively, and provides the first and second graphical values to the user interface. The user interface renders graph series for each data group using different type of lines or color on the client device associated with the user based on the first and second graphical values over the communications network.

In accordance with an exemplary embodiment of the claimed invention, each asset-date pair can be associated with a different financial asset over a same time period or can be associated with a same financial asset over a different time period.

In accordance with an exemplary embodiment of the claimed invention, the filter can divide the asset-date pairs into profitable and unprofitable groups based on the financial transactions of each asset date pair. Preferably, the time period of each asset-date pair covers purchase dates or sales dates of the financial transactions of each asset-date pair. In accordance with an aspect of the claimed invention, the financial transactions are securities transactions.

In accordance with an exemplary embodiment of the claimed invention, the controller aligns the first and second resulting values of the first and second data groups based on an user specified date for the two asset-date pairs received by the user interface from the client device associated with the user over the communications network.

In accordance with an exemplary embodiment of the claimed invention, the user interface comprises an asset entry interface for importing an input file containing the input from the client device associated with the user over the communications network. Additionally, the user interface can comprise a date selection interface for receiving the time period for analysis from the client device over the communications network. Further, the user interface can comprise a statistic selector for receiving a statistic selected by the user using the client device.

In accordance with an exemplary embodiment of the claimed invention, the processor based analytical tool evaluates the selected statistic and generates the resulting values based on the definition file associated with the selected statistic. The definition file is stored in the database and retrieved by the controller for the analytical tool.

In accordance with an exemplary embodiment of the claimed invention, the historical financial data stored in the database comprises at least one of the following data for each financial asset of the plurality of financial assets: daily pricing, daily trading volume and performance related data. In the case of stocks or bonds, such data can also include fundamental data (such as balance sheet and income statement entries) related to the underlying company.

In accordance with an exemplary embodiment of the claimed invention, a processor based computer for evaluating performance of financial transactions comprises a display, a storage device for storing the input, an input device, and a processor. The input device receives an input from a user, the input comprising information relating to at least two asset-date pairs and a statistic for measuring the performance of said at least two asset-date pairs, the information on each asset-date pair comprises identifying information of a financial asset and a time period selected by the user for analysis. The processor executes analytical tools to retrieve historical financial data on at least two asset-date pairs from a database containing historical financial data of a plurality of financial assets; to divide the retrieved historical data into groups based on association to each asset-date pair such that a first data group comprises a first historical financial data of a first asset-date pair and a second data group comprises a second historical financial data of a second asset-date pair; to respectively evaluate the statistic on the first and second data groups to provide first and second resulting values; to respectively convert the first and second resulting values to first and second graphical values; and to render graph series for each data group using different type of lines or color on the display based on the first and second graphical values. In accordance with an aspect of the claimed invention, the historical financial data can be retrieved from the database using a communications device over a communications network.

In accordance with an exemplary embodiment of the claimed invention, the processor retrieves a definition file associated with the selected statistic from the storage device, the definition file comprising instructions for calculating the selected statistic. The processor evaluates the selected statistic and generates the first and second resulting values based on the definition file. Preferably, the processor stores the resulting value and the graphical values in the storage device. In accordance with an aspect of the claimed invention, the analytical tools can be downloaded from a server using a communications device over a communications network or loaded from a computer readable medium.

In accordance with an exemplary embodiment of the claimed invention, a computer readable medium comprises computer executable code for evaluating performance of financial transactions. The computer executable code comprises instructions for receiving an input from a user, the input comprising information relating to at least two asset-date pairs and a statistic for measuring the performance of said at least two asset-date pairs, the information on each asset-date pair comprises identifying information of a financial asset and a time period selected by the user for analysis; storing the input in a storage device; requesting historical financial data on the two asset-date pairs from a database on a communications network; receiving the requested historical data from the database on the communications network; dividing the requested historical data into groups based on association to each asset-date pair such that a first data group comprises a first historical financial data of a first asset-date pair and a second data group comprises a second historical financial data of a second asset-date pair; evaluating the statistic on the first and second data group to generate first and second resulting values, respectively, by a processor; converting the first and second resulting values to first and second graphical values, respectively; and rendering graph series for each data group using different type of lines or color based on the first and second graphical values on a display. Preferably, the computer executable code further comprises instructions for retrieving a definition file associated with the selected statistic from the storage device, the definition file comprising instructions for calculating the selected statistic; and evaluating the selected statistic to generate the resulting values based on the definition file.

In accordance with an exemplary embodiment of claimed invention, the computer executable code further comprises instructions for aligning the first and second resulting values of the first and second data groups based on user specified dates for the two asset-date pairs.

Various other objects, advantages and features of the present invention will become readily apparent from the ensuing detailed description, and the novel features will be particularly pointed out in the appended claims.

### BRIEF DESCRIPTION OF THE DRAWINGS

FIG. 1 is a block diagram of the inventive system in accordance with an exemplary embodiment of the claimed invention;

FIG. 2(a) is an exemplary screenshot of the graphical result generated by the analytical tools based on the historical closing prices (represented by “CLOSE”) of a hypothetical trading history in accordance with an exemplary embodiment of the claimed invention;

FIG. 2(b) is an exemplary screenshot of the graphical result generated by the analytical tools based on the 12 period Relative Strength Index (RSI) for the same group of trades during the same period as in FIG. 2(a) in accordance with an exemplary embodiment of the claimed invention;

FIG. 2(c) is a screenshot of the graphical result generated by the analytical tools based on the 10 period, 11 period and 12 period RSI for the same group of trades during the same period as in FIG. 2(a) in accordance with an exemplary embodiment of the claimed invention;

FIG. 3 is a process flow diagram in accordance with an exemplary embodiment of the claimed invention; and

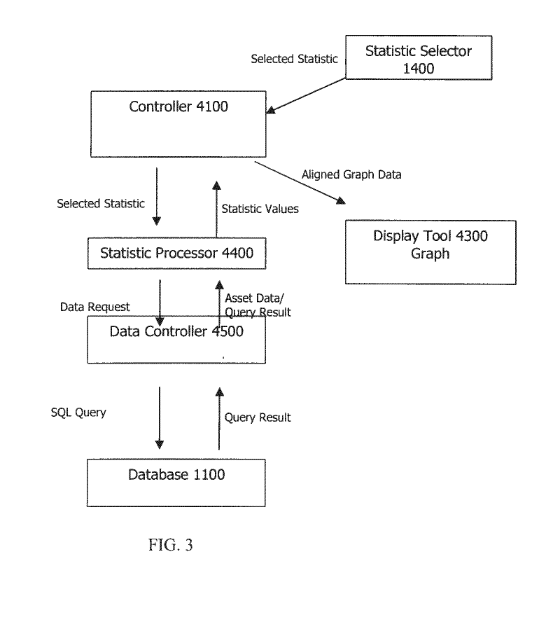

FIG. 4 is block diagram of the Web server in accordance with an exemplary embodiment of the claimed invention.

### DETAILED DESCRIPTION OF THE EMBODIMENTS

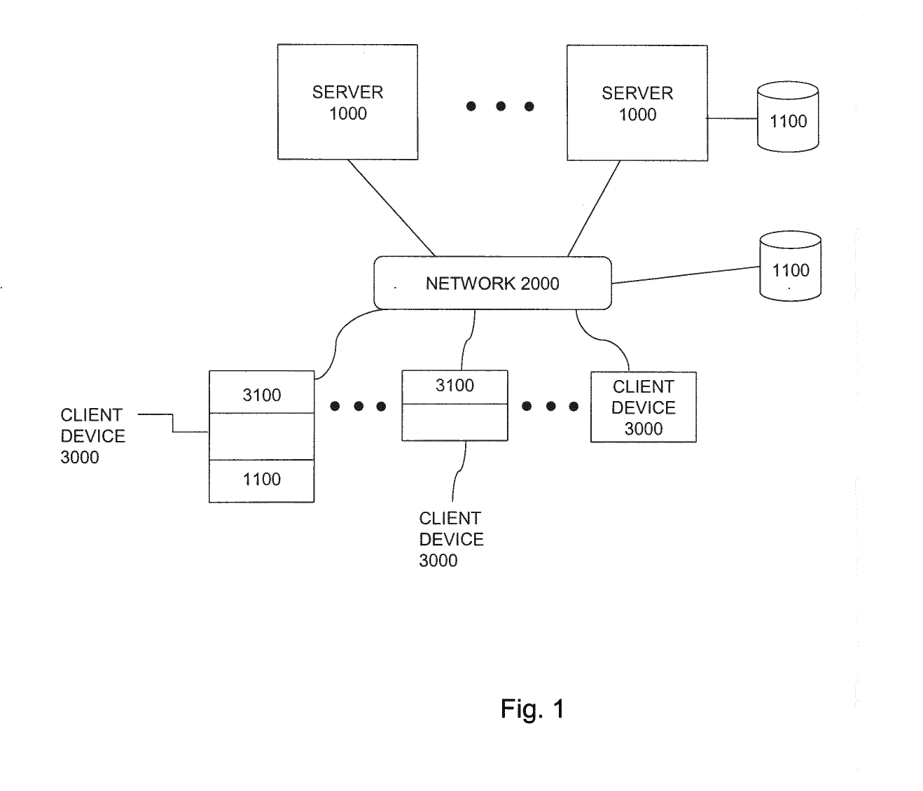

The claimed invention is directed to investors, traders and researchers of financial assets, including but not limited to stocks, commodities, currencies and derivative instruments related thereto. Specifically, the inventive system and method offers a desktop or web-based application or framework that offers a robust, intuitive and fast capability to visualize the commonality or disparity of quantitative metrics pertaining to the performance of financial assets before and/or after user-defined events or dates for different user-defined groupings of financial assets. The inventive system and method thus allows users to rapidly evaluate the pertinence of financial asset performance metrics with regard to their potential ability to portend future financial asset performance as well as assess the historical commonality or disparity of historical financial asset performance across user-defined groupings of assets after user-defined events. As such the inventive system and method acts as an intelligence platform that greatly assists users in analyzing which of the myriad financial performance metrics might be incorporated into an investing or trading strategy to improve future financial performance, as well as determine how certain events (e.g. stock splits, corporate management changes, changes of governing parties, among others) may impact financial asset performance. This capability allows for detailed research that facilitates a user's analysis of relevant data. In accordance with an exemplary embodiment of the claimed invention, such detailed research and analyses can be graphically presented as shown in FIGS. 1a-1c.

Generally, in accordance with an exemplary embodiment of the claimed invention, the inventive system can be provided as a software program that is part of a desktop or web-based application or framework such as a website that a user can access through the Internet by having an account with the website. The software program can be accessed from a website, downloaded from a website, stored on a tangible recordable medium, such as a disk, CD, DVD, flash memory or portable storage device and the like. For example, once an account is opened, the website can provide the user with the inventive software module that allows the user to view and generate various graphs by combining their historical register of asset purchases and sales with historical financial data regarding pricing, volume and corporate performance data from financial statements filed with the Securities and Exchange Commission or similar entities.

Although the description includes exemplary embodiments, it can be easily seen that other embodiments are possible, and changes can be made to the embodiments described without departing from the spirit of the disclosed system and method.

The claimed invention can be implemented using hardware, software or a combination of hardware and software. Particularly, the inventive system and method can be implemented using a computer system with a single personal computer or a network of multiple computers in local area networks, wide area networks, intranets or the Internet. The inventive application can be implemented using either object-oriented programming languages, like the JAVA™ and C++ programming languages including in particular AJAX which allows portions of a webpage to be updated without reloading a page, or procedural programming languages such as the C programming language. JAVA is a registered trademark of Sun Microsystems, Inc. The inventive system and method can be implemented as a JAVA-based application accessible by multiple end user computers on a website available over the Internet. Preferably, the inventive system and method can be implemented as a Python-based application accessible by multiple end user computers on a website available over the Internet.

In accordance with an exemplary embodiment of the claimed invention, as shown in FIG. 1, a user communicates with a computing system 1000, which can comprise a processor based Web server 1000 or multiple server computers 1000 in a client/server relationship on a communications network 2000, such as the Internet. In a client/server environment, the processor based Web server 1000 comprises a web application that communicates with a network enabled client devices 3000, which can be a personal computer (PC), a hand-held electronic device (such as a PDA), a mobile or cellular wireless phone, a TV set, or any other web-enabled electronic device as would be understood by those of skill in the art.

The inventive system can utilize any type of electronic transmission medium 2000, for example, including but not limited to the following networks: a virtual private network, a public Internet, a private Internet, a secure Internet, a private network, a public network, a value-added network, an intranet, a wireless gateway or the like. The term “virtual private network” refers to a secure and encrypted communications link between nodes on the system, a Wide Area Network (WAN), Intranet, the Internet or any other network transmission means. In addition, the connectivity to the Internet can be via, for example, Ethernet, Token Ring, Fiber Distributed Datalink Interface, Asynchronous Transfer Mode, Wireless Application Protocol, or any other form of network connectivity. In accordance with an aspect of the claimed invention, the client device 3000 can connect to the Web server 1000 using a communications device 3100, such as a modem 3100, a network interface card 3100 or the like that resides in the client device 3000.

In accordance with an exemplary embodiment of the claimed invention, the processor based Web server or the computing system 1000 comprises various analytical tools 4000 for evaluating and analyzing securities transactions to improve the profitability of investing and trading strategies. It is appreciated that all of the analytical tools 4000 need not be located at a common location (i.e., at a single Web server 1000) and can be located in several Web servers or server computers 1000. It is further appreciated that the analytical tools 4000 can be located on the client device 3000, thereby enabling the client device 3000 to operate locally in a stand alone mode. The Web server 1000 comprises a database 1100 which stores all necessary information required by the analytical tools 4000 to properly evaluate and analyze the securities transactions in accordance with an exemplary embodiment of the claimed invention. It is appreciated that the database 1100 can be separately located such the Web server 1000 and/or the client device 3000 can access the database 1100 over the on the communications network 2000. As would be well known to those of skill in the art, devices other than the hardware configurations described herein can be used to communicate with the Web server 1000. Alternatively, all of the software and hardware components can be present in a single client device 3000 such that the claimed invention can be implemented using such the single client device 3000. That is, the client device 3000 comprises the database 1100, analytical tools 4000 and the various user interfaces described herein to communicate with the user such that the inventive system can be practiced with a single client device 3000 operating locally in a stand alone mode without the communications network 2000 and the communications device 3100.

In accordance with an exemplary embodiment of the claimed invention, the analytical tools 4000 of the Web Server 1000 utilize various inputs to evaluate/analyze securities transactions to improve the profitability of investing and trading strategies. These inputs can include but are not limited to: 1) a collection of assets (the “Assets”); 2) historical data containing information about the Assets (the “Data”); 3) a collection of possible statistics that the user may use to analyze the Assets (the “Statistics”); and 4) a date for each Asset (which may or may not be the same for all Assets) (collectively, the “Dates”) on which to align the series in the displayed graph. Several different analytical tools or components 4000, each of which can have different variants for specific embodiments to perform different specific analyses, are employed to receive various inputs from the user, to perform the calculations required for a specific analysis and to visually display the analytical results to the user on the client device 3000 associated with the user, i.e., the associated client device 3000.

Various analytical tools 4000 of the Web server 1000 will now be described herein. In accordance with an exemplary embodiment of the claimed invention, the analytical tools 4000 comprises a controller 4100 which responds to the user's inputs and commands received from the associated client device 3000 using one of the available user interfaces over the communications network 2000. The controller 4100 manages the flow of information among various analytical tools 4000 and activity with regard to performing the analysis and rendering the results by a display tool 4300. Preferably, the controller 4100 comprises a storage device 4110, such as memory, hard disk, and the like, for storing inputs and/or commands received from the associated client device 3000. Alternatively, the controller 4100 can store the inputs and/or commands received from the associated client device 3000 in the database 1100. The display tool 4300 manages graph areas displayed on the associated client device 3000, for example in the form of a webpage.

In accordance with an exemplary embodiment of the claimed invention, the Web server 1000 comprises an asset entry interface or module 1200 for entering the Assets to be analyzed by one or more analytical tools 4000. Preferably, the asset entry interface 1200 receives a list of identifiers relating to the Assets to be analyzed by the analytical tools 4000 from the user through the client device 3000 associated with the user over the communications network 2000. For example, the list of identifiers can be in the form of a collection of asset identifiers such as a text array of stock tickers. In another example, the list of identifiers can be a collection of historical transactions that includes an asset identifier that identifies the purchased asset, the purchase date and purchase price of the asset, and the selling date and selling price of the asset. In accordance with an exemplary embodiment of the claimed invention, the asset entry interface 1200 displays a series of dialog boxes on the associated client device 3000 to prompt the user to enter or select a stock ticker, currency identifier, or other similar asset identifier. Preferably, the user can use the asset entry interface 1200 import information regarding a collection of transactions from a computer file which contains information with regard to which assets are to be analyzed, the dates on which such transactions occurred or are deemed to have occurred, and information for separating the Assets into various pertinent groups (e.g. profitability of the transaction, the industry group of a stock Asset, or a user-defined group label) by the analytics tools 4000. In accordance with an exemplary embodiment of the claimed invention, the analytical tools 4000 can perform a backtest of a trading strategy and generates a set of hypothetical transactions that would have been entered into pursuant to that trading strategy. The list of Assets stored in the database 1100 is accessed or retrieved by the controller 4100 so the analytical tools 4000 can perform the requisite analysis to improve the profitability of the trading strategy.

In accordance with an exemplary embodiment of the claimed invention, the analytical tools 4000 comprises a filter 4200 for dividing or classifying the Assets on the list of Assets into different groups based on certain criteria received from the user or based on a default criteria, which can be rendered in a different color or pattern for graphical purposes by the display tool 4200. For example, the filter 4200 can divide the Assets into two groups based on whether historical transactions of the Assets were profitable or unprofitable; multiple groups based on the industry in which the underlying company operates; multiple groups based on the timeframe during which historical transactions of the Assets occurred (e.g. during recessions or not, during Republican or Democratic presidencies, and the like); multiple groups based on designations that the user specifies, such as Group 1 or Group 2; multiple groups based on the stock exchange on which the Assets trade (e.g. NYSE, AMEX, NASDAQ, and the like); multiple groups based on the price range paid for the Assets, and the like. In accordance with an exemplary embodiment of the claimed invention, FIGS. 1(a)-(c) are exemplary screenshots of dividing the Assets into profitable and unprofitable transactions. A straight full line represents Assets underlying profitable transactions and a bold dotted line represents Assets underlying unprofitable transactions. When the user selects a specific criterion for dividing or classifying the Assets using the asset entry tool 1200, the controller 4100 is notified of the selection. The controller 4100 instructs the filter 4200 to divide the Assets into separate groups based on the user selected criteria.

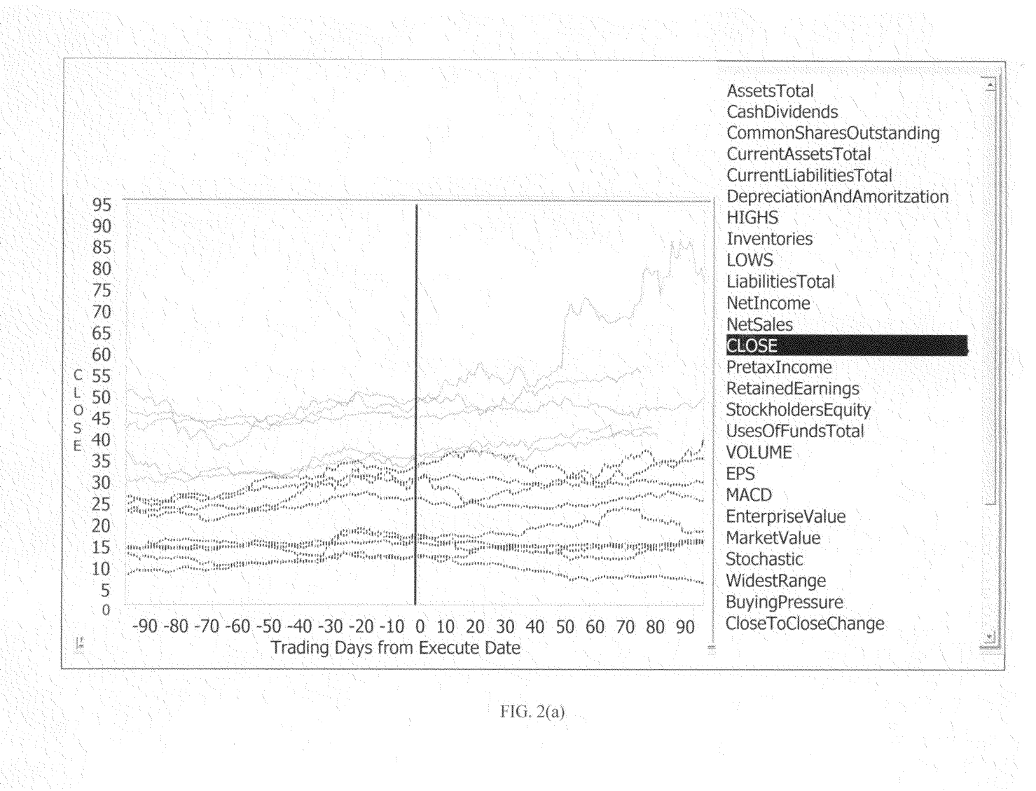

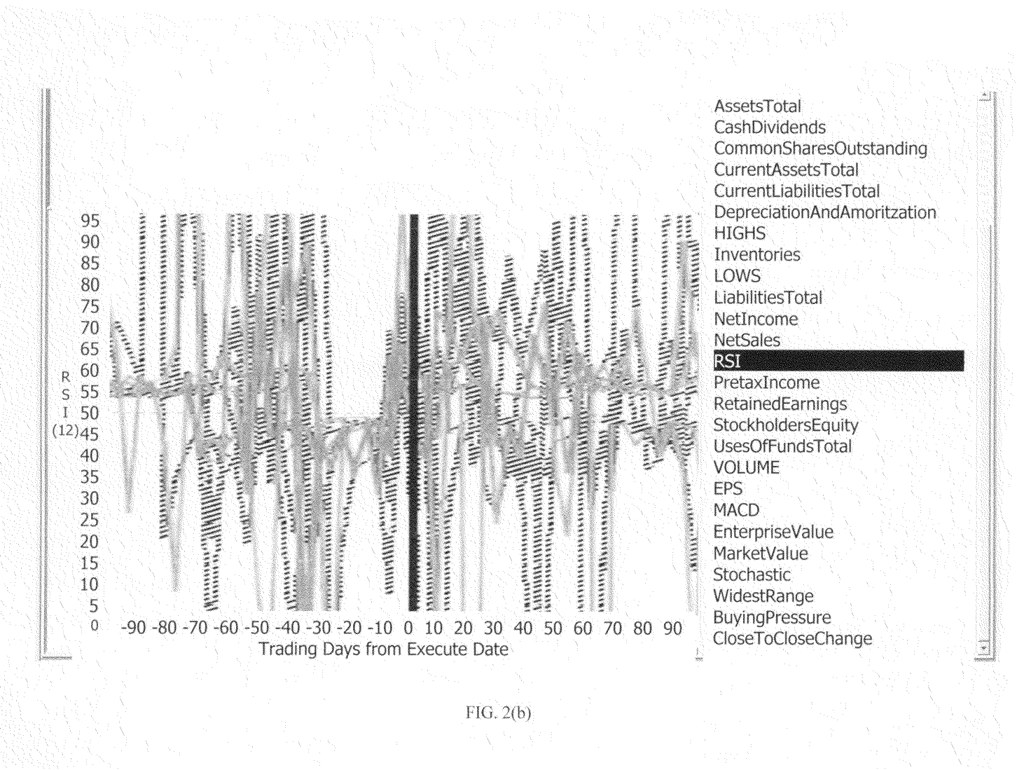

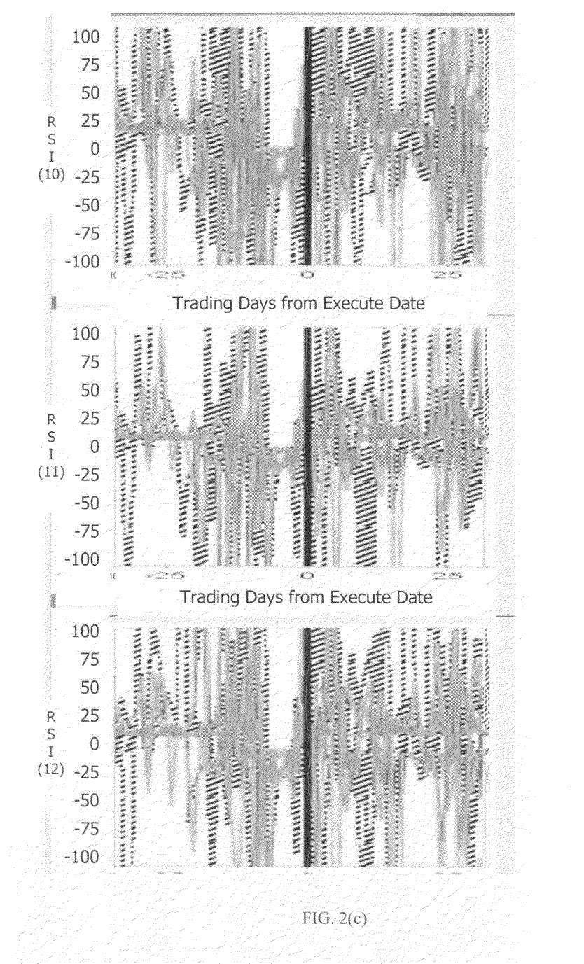

Turning now to FIG. 2(a), which is an exemplary screenshot of the graphical result generated by the analytical tool 4000 based on the historical closing prices (represented by “CLOSE”) of a hypothetical trading history in accordance with an exemplary embodiment of the claimed invention. Closing price of profitable transactions (straight full lines) and unprofitable transactions (bold dotted lines) for each of the 100 trading days before and after the execution date of each transaction is shown in FIG. 2(a). The analytical tool 4000 has aligned all of the execution dates of the trades at time 0 in FIG. 2(a). As graphically shown in FIG. 2(a), the analytical tools 4000 has identified a trading strategy that may potentially improve the user's profitability with future trades or minimize unprofitable trades in the future based on this hypothetical trading history. That is, as shown in FIG. 2(a), all of the straight full lines cross the vertical 0 line above $35 and all of the bold dotted lines cross the vertical 0 line below $35. Accordingly, based on this hypothetical trading history, the analytical tools 4000 of the claimed invention has identified that if the trader adopts a trading strategy or criterion of only purchasing assets priced over $35, she can potentially avoid unprofitable trades and improve her future trading profitability.

FIG. 2(b) is an exemplary screenshot of the graphical result generated by the analytical tools 4000 relating to the Relative Strength Index (RSI) for the same group of trades during the same period as in FIG. 2(a) in accordance with an exemplary embodiment of the claimed invention. That is, FIG. 2(b) graphically illustrates the historical values of the 12 period Relative Strength Index for the same group of trades during the same period as in FIG. 2(a). As graphically shown in FIG. 2(b), the analytical tools 4000 did not identify any material difference in the hypothetical trading history with respect to the RSI. That is, there are no material differences in FIG. 2(b) between the straight full and bold dotted lines to the left of the vertical 0 line (i.e. prior to the dates they would have executed each respective trade). Accordingly, the analytical tools 4000 could not improve the trader's future trading profitability utilizing the RSI indicator or statistics.

FIG. 2(c) is a screenshot of the graphical result generated by the analytical tools based on the 10 period, 11 period, and 12 period RSI for the same group of trades during the same period as in FIG. 2(a) in accordance with an exemplary embodiment of the claimed invention. The graphical results in FIG. 2(c) are displayed utilizing the filmstrip feature of the invention. As graphically shown in FIG. 2(c), the analytical tools 4000 did not identify any material difference in the hypothetical trading history with respect to the three periods of RSI. That is, as with FIG. 2(b), there are no material differences in FIG. 2(c) between the straight full and bold dotted lines to the left of the vertical 0 line (i.e. prior to the dates they would have executed each respective trade). Accordingly, the analytical tools 4000 could not improve the trader's future trading profitability utilizing the RSI indicator or statistics.

In accordance with an exemplary embodiment of the claimed invention, the Web server 1000 comprises a date selection interface or module 1300 for receiving a period from the user on which to align the graph series by the analytical tools 4000. For example, in FIG. 2(a), the analytical tools 4000 aligned all of the execution dates of the trades (i.e., graph series) at time 0. The date selection interface 1300 notifies the controller 4100 on which date to align each series in the graph. The user uses the date selection interface 1300 through the associated client device 3000 to select or enter various dates associated with the underlying transactions to align the graph series. For example, the user can enter or select the execution dates of the underlying transactions (e.g. the date on which an underlying Asset was purchased or sold short); the unwind dates of the underlying transactions (e.g. the dates the purchased Assets were sold or shorted Assets were repurchased in the market); a date and identifier of an asset and see any of the statistics before and after the date entered; and the like The date selection interface 1300 notifies the controller 4100 of the dates selected for the analysis by the user/operator. The controller 4100 causes the analytical tools 4000 to evaluate the selected statistics and graphically display the results based on the user selected date for each graph series (i.e., each asset). That is, the graph series for each Asset, such as those shown in FIG. 2(a), is aligned such that the period representing the user-selected date for each graph series is rendered on the vertical 0 axis of the resulting graph generated by the analytical tools 4000.

In accordance with an exemplary embodiment of the claimed invention, the Web server 1000 comprises a statistic selector 1400 for selecting the statistics to be analyzed by the analytical tools 4000. The statistic selector 1400 can automatically select a statistic or a set of statistics to be analyzed by the analytical tools 4000. Alternatively, the statistic selector 1400 receives and manages the statistics that the user selects for the analytical tools 4000 to use in analyzing the trading data. The term “statistic” or “indicator” as used herein is a representation of a mathematical calculation to be performed by the analytical tools 4000 on Asset data. Preferably, each indicator or statistic can be defined in an electronic file that is stored in the database 1100. The electronic file can be included in a library and distributed to the user with the claimed system on a recordable medium or the user can download the file and the claimed system from a provider's website. In accordance with an aspect of the claimed invention, the user can use the statistic selector 1400 to generate or select one of a plurality of statistics, including but not limited to: 1) pricing information about the underlying assets (e.g. a stock's price at the market open of each trading day, at the market close of each trading day, the intraday high or low price); 2) volume information indicating the number of shares of the underlying asset traded on each trading day; 3) financial information about the asset (e.g. information from SEC financial filings made by the companies whose shares are traded); 4) other statistics derived from the above information (e.g. technical indicators, financial ratios), which can be generated by the user or supplied by the claimed system. If the statistics selector 1400 requires additional input from the user to evaluate the trading data based on the selected statistic, e.g. the Moving Average Convergence/Divergence indicator requires two inputs, each used to specify the timeframe of a moving average of asset prices, the statistic selector 1400 prompts the user for example via a dialog box, to enter the inputs to be analyzed. Any and all methods for prompting a user are contemplated by the claimed invention as would be well understood by those of skill in the art.

In accordance with an exemplary embodiment of the claimed invention, the analytical tools 4000 comprise a statistic processor 4400. Once the user has selected the statistic to be analyzed, the statistic selector 1400 notifies the controller 4100 of the user's statistic selection. The controller 4100 forwards the selected Assets information, the selected dates and selected statistics to the statistic processor 4400. The statistic processor 4400 calculates the values of the selected statistic for each Asset for the specified time period before and after the user-defined dates, preferably, the statistic processor 4400 generates graphical results as shown in FIGS. 2(a)-(c). Once the time period to align the graph series and the statistic to be analyzed has been determined and/or entered by the user and received by the controller 4100, the statistic processor 4400 calculates the values of the selected statistic for each asset in each group for the trading days before and after the event date. Where appropriate, the statistic processor 4400 may request additional data from the database 1100 to calculate the values of the selected statistics. For example, the additional data can be data related to the Asset (or “Asset Data”), such as the closing price. An exemplary operation of the statistic processor 4400 is now described using the following example. If the Asset underlying a profitable transaction is shares of company A, which were purchased on Jan. 14, 2005 (i.e., the execution date) and the selected statistic is the closing price of the Asset, the statistic processor 4400 generates a graphic series based on the closing price of stock A starting some predetermined number of days before and after the execution date of Jan. 14, 2005. If the Asset underlying an unprofitable transaction is for shares of company B purchased on Mar. 17, 2005, then the statistic processor 4400 generates another graphic series based on the closing prices for stock B for the same number of days before and after Mar. 17, 2005. Preferably, the statistic processor 4400 generates graphical results that can be displayed on the client device 3000 by the display tool 4300. The statistic processor 4400 provides the graphical results (i.e., values necessary for rendering a graph, such as shown in FIGS. 2(a)-(c)) to the controller 4100, which forwards the graphical results to the display tool 4300. In accordance with an aspect of the claimed invention, the statistic processor 4400 generates graphical results whereby the series values are equal to the selected statistic on each period divided by the value of the statistic at time 0. This results in each series data being a percentage of the value on its alignment date.

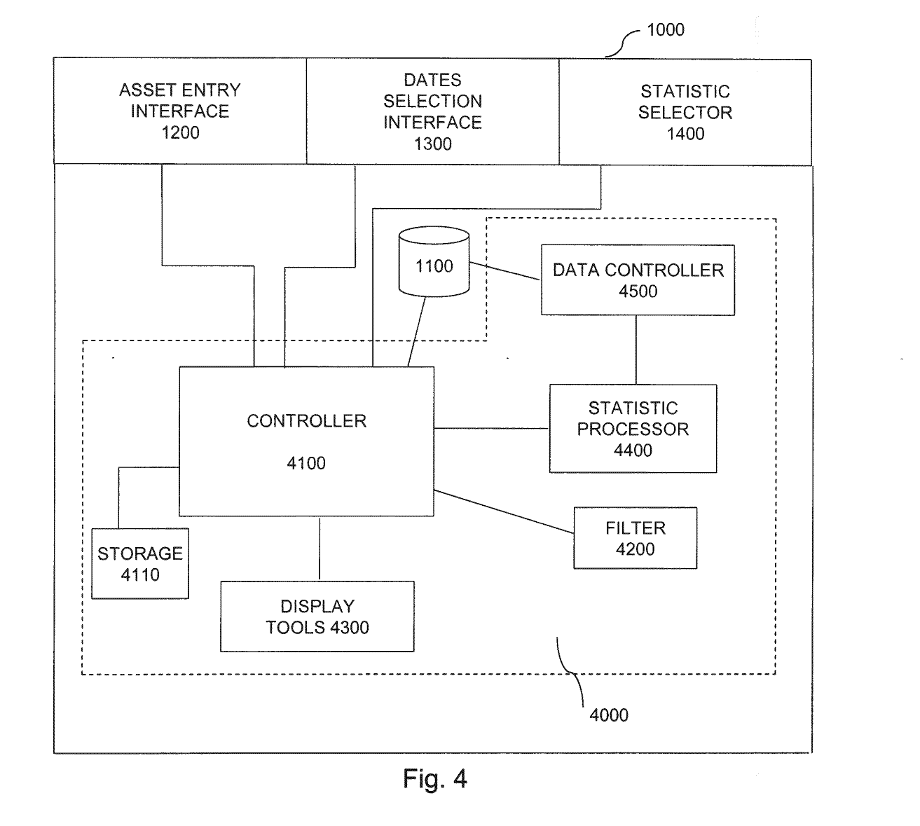

In accordance with an exemplary embodiment of the claimed invention, the analytical tools 4000 comprise a data controller 4500 for retrieving information related to the Assets or Asset Data. In accordance with an exemplary embodiment of the claimed invention, Asset Data are stored in the storage device or database 1100 or the like. Although the database 1100 is shown in FIGS. 1 and 4, as residing on the processor based Web server 1000, it can reside on the client device 3000 in the form of a hard disk, CD, DVD or other digital storage medium/device accessible by the user and the analytical tools 4000. When a statistic being calculated by the statistic processor 4400 depends upon a field of historical data pertaining to an Asset, such as the closing price of a stock A, the data controller 4500 retrieves that Asset Data from the database 1100. In accordance with an exemplary embodiment of the claimed invention, the data controller 4500 generates a SQL query that causes a relational database 1100 to return a result set that includes the required data field for the Asset over the date range required to calculate the statistic by the statistic processor 4400.

In accordance with an exemplary embodiment of the claimed invention, the display tool 4300 manages the display and renders of the graph results on the client device 3000 over the communications network 2000. Upon receipt of the graphical results generated by the statistic processor 4400 from the controller 4100, the display tool 4300 renders graph series based on the closing prices of both transactions aligned with their respective execution dates. That is, the points representing Jan. 14, 2005 for stock A and Mar. 17, 2005 for stock B would be located on the vertical line above the 0 on the x-axis of the rendered graph on the client device 3000. The portions of the graph series to the left of the line 0 would represent the prices for each of the stocks A and B prior to the date their respective execution dates; the portions of the graph series to the right of the line 0 would represent the prices for each of the stocks A and B after their respective execution dates. Similar to FIG. 2(a), the graph series representing the profitable stock A transactions would be displayed in straight full lines and the graph series representing the unprofitable stock B transactions would be displayed in bold dotted lines. The display tool 4300 comprises a model of a specific x, y coordinates for each point to be displayed in each line representing the values of the selected statistic for each Asset selected by the user and calculated by the analytics tools 4000, as noted herein. These x, y coordinates can be displayed on a graph as line series, whereby a straight line is rendered for each series between each consecutive points of x, y coordinates. Although the graphical results are shown in straight and dotted line series, other graphic series are contemplated by the claimed invention, such as colored line series and the like. The display tool 4300 also contains information with regard to which color or pattern to use to draw the lines with regard to each grouping of Assets as divided by the filter 4200. For example, the display tool 4300 can cause each line representing an Asset related to profitable transactions to be drawn in straight full or green line and each line representing an Asset related to unprofitable transactions to be drawn in bold dotted or red line.

In accordance with an exemplary embodiment of the claimed invention, the controller 4100 receives user input from various user interfaces (1200, 1300, 1400) of the Web server 1000 and controls various analytical tools (4200, 4300, 4400) of the claimed invention. The controller 4100 receives all of the information input by the user using the asset entry interface 1200, the date selection interface 1300 and the statistic selector interface 1400 over the communications network 2000. The controller 4100 instructs the statistic processor 4400 to calculate the values of the user-selected statistic for each Asset for the periods before and after the selected dates. The controller 4100 then aligns the results generated by the statistic processor 4400 such that the selected dates render at the same point 0 on the graph to be displayed on the client device 3000. The controller 4100 then places the aligned results of the calculations as a collection of x, y coordinates into the model contained in the display tool 4300, which updates the display on the client device 3000 by rendering each graph series herein and exemplary shown in FIGS. 2(a)-(c). Alternatively, the controller 4100 can instruct the statistic processor 4400 to calculate the mean and/or median values of each grouping and can instruct the display tool 4300 to render the mean and/or median values in addition to or in place of the individual Asset graph series on the client device 3000 over the communications network 2000.

The following describes the computer-based method for implementing the claimed invention using processor-executable instructions for directing operation of a device or devices under the processor control. In accordance with an embodiment of the claimed invention, the processor-executable instructions can be stored on a tangible computer-readable medium, such as a disk, CD, DVD, flash memory, portable storage or the like. The processor-executable instructions can be accessed from a service provider's website or stored as a set of downloadable processor-executable instructions, for example, or downloading and installation from an Internet location (e.g., Web server).

Exemplary embodiments of the inventive processes of the claimed invention will be described in conjunction with the following example. The example will assume a scenario where the user instructs the analytical tools 4000 to analyze a statistic of “ClosingPrice*b 10” for the period of 2 days before and after the execution date of each transaction for a collection of historical transactions where one transaction was for asset ABC purchased on Jan. 3, 2000 for $12 and sold later at a profit for $20 and the second transaction was for asset DEF purchased on Aug. 1, 2001 for $50 and sold later at a loss for $30.

In accordance with an exemplary embodiment of the claimed invention, the user imports a file located on her computer with the results of a strategy backtest to the Web server 1000 over the communications network 2000 using the asset entry interface 1200. The file contains information about two transactions: one transaction was for asset ABC purchased on Jan. 3, 2000 for $12 and sold later at a profit for $20 and the second transaction was for asset DEF purchased on Aug. 1, 2001 for $50 and sold later at a loss for $30.

Using the date selection interface 1300, the user selects “Winner/Loser 2 Day Execute Date Analysis”, which represents a time period of two days. That is, the analytical tools 4000 will analyze these two transactions by focusing on the 2 days before and after the execution date for each Asset. Also, the user's selection of “Winner/Lose 2 Day Execute” will essentially notify the controller 4100 to instruct the filter 4200 to categorize the Assets (stocks ABC and DEF) into two groups: profitable (e.g. “Winner”) and unprofitable (e.g. “Loser”) transactions. For example, the controller 4100 sends the list of transactions to the filter 4200 for processing into Winner and Loser groups.

The date selection interface 1300 also notifies the controller 4100 that the analysis will be based on the execution dates of these two transactions. For example, the controller 4100 later instructs the statistic processor 4300 to calculate the selected statistic for each day between Jan. 1, 2000 and Jan. 5, 2000 for Asset ABC (i.e. from two days before the execution date of Jan. 3, 2000 to two days after) and for each day between Jul. 30, 2001 and Aug. 3, 2001 for Asset DEF (i.e. from two days before the execution date of Aug. 1, 2001 to two days after).

The filter 4200 reviews each transaction in the list and determines whether they were profitable (e.g. sale price minus purchase price>0) or unprofitable (e.g. sale price minus purchase price <=0). For example, “ABC” is included in the Winner group ($20−$12=8>0) and “DEF” is included in the Loser group ($30−$50=−$20<0). The filter 4200 returns the Winner and Loser groups to the controller 4100.

In accordance with an exemplary embodiment of the claimed invention, the client device 3000 displays a blank graph and the statistic selector interface 1400 represented by a box containing a list of names representing the available statistics that can be analyzed by the analytical tools 4000 to the user. For example, one of the statistics available is labeled “ClosingPrice*10”, which the user selects in this example. The statistic selector interface 1400 notifies the controller 4100 that the “ClosingPrice*10” statistic has been selected by the user. It is appreciated that the “ClosingPrice*10” is just a hypothetical statistic to describe the claimed invention in operation. The claimed invention can operate with virtually any statistic generated and input by the user. Other exemplary statistics include technical indicators and fundamental metrics and ratios, such as are set forth in the right hand box in FIG. 2(a): AssetsTotal, CashAndShortTermInvestments, CashDividends, CommonSharesOutsanding, CommonSharesOutstandForDiluteEPS, MACD, Sotchastic, etc.

In accordance with an exemplary embodiment of the claimed invention, the controller 4100 retrieves and opens the definition file for “ClosingPrice*10,” which can comprise instructions for calculating the selected statistic. The controller can retrieve the definition file stored in either the storage device 4110 or in the database 1100. It is appreciated that every statistic comprises one or more references to data fields included in the historical asset data, i.e., Asset Data, stored in the database 1100. For example, the instructions can indicate that the historical data in the ClosingPrice field in the database 1100 should be multiplied by 10. The controller 4100 sends the list of Assets, the required dates for each asset (each day between Jan. 1, 2000 and Jan. 5, 2000 for Asset ABC and for each day between Jul. 30, 2001 and Aug. 3, 2001 for Asset DEF) and the statistic instructions to the statistic processor 4400.

In accordance with an exemplary embodiment of the claimed invention, the statistic processor 4400 evaluates the statistic for every Asset in the list received from the controller 4100 for the specified date ranges. The statistic processor 4400 calculates the values of the selected statistic selected by the user by requesting the requisite information about the Asset (e.g., closing prices of the Asset over the desired time period) from the data controller 4500. For example, the statistic processor 4400 requests the data controller 4500 to provide the required field(s) of historical data for the specified Asset. For example, when processing Asset ABC, the statistic processor 4400 requests the values of the “ClosingPrice” field for Asset ABC between Jan. 1, 2000 and Jan. 5, 2000.

In response to the request for data from the statistics processor 4400, in accordance with an exemplary embodiment of the claimed invention, the data controller 4500 generates a SQL query (e.g. SELECT ClosingPrice FROM PricingDataTable WHERE PricingDataTable.AssetID=“ABC” and PricingDataTable.date>=Jan. 1, 2000 and PricingDataTable.date<=Jan. 5, 2000) and submits the query to the database 1100, which processes the query.

In response to the SQL query, in accordance with an exemplary embodiment of the claimed invention, the database 1100 provides the query result set to the data controller 4500, which conveys the query results to the statistic processor 4400 as a numerical array. For example, the data controller 4500 can return an array with the values {10, 11, 12, 13, 14} to the statistic processor 4400, where each entry represents asset ABC's ClosingPrice on each day between Jan. 1, 2000 and Jan. 5, 2000, respectively. The data controller 4500 can return an array with the values {60, 55, 50, 40, 45} to the statistic processor 4400 in response to the same query for Asset DEF.

In accordance with an exemplary embodiment of the claimed invention, the statistic processor 4400 applies the calculations and rules as defined in the definition file of the selected statistic and provides the resulting values to the controller 4100. For example, if the statistic definition file specifies that the ClosingPrice should be multiplied by 10, then the statistic processor 4440 multiplies each entry in the data received from the data controller 4500 by 10 and conveys an array with the values {100, 110, 120, 130, 140} to the controller 4100, where each entry represents Asset ABC's ClosingPrice multiplied by 10 on each day between Jan. 1, 2000 and Jan. 5, 2000, respectively. The array for Asset DEF would be {600, 550, 500, 400, 450}, for each entry represents Asset DEF's ClosingPrice multiplied by 10 on each day between Jul. 30, 2001 to Aug. 3, 2001.

The controller 4100 populates a graph model in the display tool 4300 with x, y coordinates for each series. In this example, series ABC would contain (−2, 100), (−1, 110), (0, 120), (1, 130), (2, 140) and series DEF would contain (−2, 600), (−1, 550), (0, 500), (1, 400), (2, 450). In accordance with an exemplary embodiment of the claimed invention, the controller 4100 instructs the display tool 4300 to render graph series ABC in solid or green lines because it belongs to the “Winner” group and to render graph series DEF in dashed or red lines because it belongs to the “Loser” group. The display tool 4300 causes a line graph to be rendered on the client device 3000, preferably on the screen of the client device, where there is one solid or green line connecting each (x, y) point of the series ABC and one dashed or red line connecting each (x, y) point of the series DEF.

The claimed invention has many advantages over the prior art system, including but not limited to being highly visual, intuitive and fast. By allowing a user to quickly and easily select the statistic of interest without having to modify any computer script or run a backtest, the claimed invention provides easy to use analytical tools 4000 for evaluating and analyzing transactions to identify meaningful statistics or indicators to potentially improve her trading profitability. In the exemplary analysis described herein, the analytical tools 4000 of the claimed invention provided meaningful information to enable the user to quickly ascertain that the ClosingPrice*b 10 for the profitable transaction (ABC) was significantly lower than for the unprofitable transaction (DEF) prior to their respective execution dates. Also, based on the result generated by the analytical tools 4000, the user might consider only investing in assets with ClosingPrice*b 10 less than 300 in the future because such investing strategy would have avoided all of her unprofitable transactions in the past.

Although the claimed invention has been described in considerable detail with reference to various embodiments thereof, other embodiments are also possible. For example, instead of filtering the groups based on profitable/unprofitable transactions, the filter 4200 can divide the groups based on industry, currency or continent of currency. Also, rather than analyzing past transactions, the user can enter the dates of historical lawsuits filed against a group of tobacco companies and a group of asbestos companies along with the ticker symbols of those companies, so the analytical tools 4000 can determine if the stock prices in these two groups of companies behaved differently after the lawsuits were filed. The inventive system can be implemented as a singular system running on a client device, can be separately integrated into any applicable application, or can be integrated into a webpage. The inventive system enables various entry or manipulation of the data, such as selected statistic being dragged, dropped, and manipulated in a variety of ways, including by keyboard, mouse, stylus, touch screen, or touchpad. It should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A processor based server for evaluating performance of financial transactions, comprising:
a database containing historical financial data of a plurality of financial assets;
an user interface for communicating with a plurality of client devices over a communications network, said user interface receiving an input from a client device associated with a user to over said communications network, said input comprising information relating to at least two asset-date pairs and a statistic for measuring the performance of said at least two asset-date pairs, the information on each asset-date pair comprises identifying information of a financial asset and a time period selected by the user for analysis;
a controller receiving said input from said user interface, storing said input in a storage device, requesting said historical financial data on said at least two asset-date pairs from said database, and receiving said requested historical data from said database;
a filter for dividing said requested historical data into groups based on association to each asset-date pair such that a first data group comprises a first historical financial data of a first asset-date pair and a second data group comprises a second historical financial data of a second asset-date pair;
a processor based analytical tool receiving said statistic, said first data group and said second data group from said controller, evaluating said statistic on said first and second data groups to provide first and second resulting values, respectively, to said controller; and
wherein said controller converts said first and second resulting values from said processor based analytical tool to first and second graphical values, respectively, and provides said first and second graphical values to said user interface; and
wherein said user interface renders graph series for each data group using different type of lines or color on said client device associated with said user based on said first and second graphical values over said communications network.

2. The processor based server of claim 1, wherein each asset-date pair is associated with a different financial asset over a same time period or is associated with a same financial asset over a different time period.

3. The processor based server of claim 1, wherein said filter divides said at least two asset-date pairs into profitable and unprofitable groups based on said financial transactions of each asset-date pair.

4. The processor based server of claim 1, wherein said time period of each asset-date pair covers purchase dates or sale dates of said financial transactions of said each asset-date pair.

5. The processor based server of claim 1, wherein said financial transactions are securities transactions.

6. The processor based server of claim 1, wherein said user interface comprises an asset entry interface for importing an input file containing said input from said client device associated with the user over said communications network.

7. The processor based server of claim 1, wherein said user interface comprises a statistic selector for receiving a statistic selected by said user using said client device over said communications network; wherein said controller retrieves a definition file associated with said selected statistic from said storage device, said definition file comprising instructions for calculating said selected statistic; and wherein said processor based analytical tool evaluates said selected statistic for said first and second data groups and generates said first and second resulting values based on said definition file.

8. The processor based server of claim 1, wherein said historical financial data stored in said database comprises at least one of the following data for each financial asset of said plurality of financial assets: pricing, trading volume, performance related data and fundamental data of an underlying company if financial asset is a stock or bond.

9. The processor based server of claim 1, wherein the controller aligns said first and second resulting values of said first and second data groups based on user specified dates for said at least two asset-date pairs received by said user interface from said client device associated with the user over said communications network.

10. A processor based computer for evaluating performance of financial transactions, comprising:
a display;
an input device receiving an input from a user, said input comprising information relating to at least two asset-date pairs and a statistic for measuring the performance of said at least two asset-date pairs, the information on each asset-date pair comprises identifying information of a financial asset and a time period selected by the user for analysis;
a storage device storing said input; and
a processor executing analytical tools to retrieve historical financial data on said at least two asset-date pairs from a database containing historical financial data of a plurality of financial assets, to divide said retrieved historical data into groups based on association to each asset-date pair such that a first data group comprises a first historical financial data of a first asset-date pair and a second data group comprises a second historical financial data of a second asset-date pair, to respectively evaluate said statistic on said first and second data groups to provide first and second resulting values, to respectively convert said first and second resulting values to first and second graphical values, and to render graph series for each data group using different type of lines or color on said display based on said first and second graphical values.

11. The processor based computer of claim 10, wherein each asset-date pair is associated with a different financial asset over a same time period or associated with a same financial asset over a different time period.

12. The processor based computer of claim 10, wherein said processor aligns said first and second resulting values of said first and second data groups based on user specified dates for said at least two asset-date pairs.

13. The processor based computer of claim 10, wherein said analytical tools are downloaded from a sever using a communications device over a communications network or loaded from a computer readable medium.

14. The processor based computer of claim 10, wherein said historical financial data on said at least two asset-date pairs are retrieved from said database using a communications device over a communications network.

15. The processor based computer of claim 10, wherein said processor retrieves a definition file associated with said statistic from said storage device, said definition file comprising instructions for calculating said selected statistic; and wherein said processor evaluates said selected statistic and generates said resulting values based on said definition file.

16. The processor based computer of claim 10, wherein said processor stores said resulting value and said graphical values in said storage device.

17. The processor based computer of claim 10, wherein said analytical tool divides said at least two asset-date pairs into profitable and unprofitable groups based on said financial transactions of each asset-date pair.

18. The processor based computer of claim 10, wherein said time period of each asset-date pair covers purchase dates or sale dates of said financial transactions of said each asset-date pair.

19. A computer readable medium comprising computer executable code for evaluating performance of financial transactions, said computer executable code comprising instructions for
receiving an input from a user, said input comprising information relating to at least two asset-date pairs and a statistic for measuring the performance of said at least two asset-date pairs, the information on each asset-date pair comprises identifying information of a financial asset and a time period selected by the user for analysis;
storing said input in a storage device;
requesting historical financial data on said at least two asset-date pairs from a database containing historical financial data of a plurality of financial assets on a communications network;
receiving said requested historical data from said database on said communications network;
dividing said requested historical data into groups based on association to each asset-date pair such that a first data group comprises a first historical financial data of a first asset-date pair and a second data group comprises a second historical financial data of a second asset-date pair;
evaluating said statistic on said first and second data groups to generate first and second resulting values, respectively, by said processor;
converting said first and second resulting values to first and second graphical values, respectively; and
rendering graph series for each data group using different type of lines or color based on said first and second graphical values on a display.

20. The computer readable medium of claim 19, further comprising instructions for retrieving a definition file associated with said statistic from said storage device, said definition file comprising instructions for calculating said statistic; and evaluating said statistic to generate said first and second resulting values based on said definition file.

21. The computer readable medium of claim 19, further comprising instructions for receiving information on each asset-date pair that is associated with a different financial asset over a same time period or associated with a same financial asset over a different time period.

22. The computer readable medium of claim 19, further comprising instructions for aligning said first and second resulting values of said first and second data groups based on user specified dates for said at least two asset-date pairs.

23. The computer readable medium of claim 19, further comprising instructions for dividing said at least two asset-date pairs into profitable and unprofitable groups based on said financial transactions of each asset-date pair.

24. The computer readable medium of claim 19, further comprising the instructions for receiving said time period of each asset-date pair which cover purchase dates or sale dates of said financial transactions of said each asset-date pair from the user.
